(19) United States
(12) Patent Application Publication
(10) Pub. No.: US 2011/0236775 A1
(43) Pub. Date: Sep. 29, 2011

(54) Fuel Cell System

(75) Inventors: Gi-Jang Ahn, Yongin-si (KR); Jun-Pyo Park, Yongin-si (KR); Ki-Woon Kim, Yongin-si (KR); Seong-Jin An, Yongin-si (KR); Hyun Kim, Yongin-si (KR)

(73) Assignee: Samsung SDI Co., Ltd., Yongin-si (KR)

(21) Appl. No.: 12/906,667

(22) Filed: Oct. 18, 2010

(30) Foreign Application Priority Data
Mar. 26, 2010 (KR) 10-2010-0027428

(51) Int. Cl. H01M 8/06

(52) U.S. Cl. 429/410; 429/423

(57) ABSTRACT

A fuel cell system quickly and efficiently preheats a frozen stack. The fuel cell system includes: a reformer which generates a reformate gas by reforming a fuel and is heated by a heat source unit; a stack which generates electricity by electrochemically reacting an oxidizer with hydrogen in the reformate gas; and a fluid flow controller which moves air around the reformer into an area around the stack, and which controls airflow on the basis of a temperature change of the stack, wherein the air is heated by the surface temperature of the reformer.

### CLAIM OF PRIORITY

This application makes reference to, incorporates the same herein, and claims all benefits accruing under 35 U.S.C. §119 from an application earlier filed in the Korean Intellectual Property Office on Mar. 26, 2010 and there duly assigned Serial No. 10-2010-0027428.

### BACKGROUND OF THE INVENTION

1. Field of the Invention

The invention relates to a fuel cell system and, more particularly, to a fuel cell system which can quickly and efficiently preheats a cold stack.

2. Related Art

Fuel cells are devices which generate electric energy by electrochemically reacting a fuel with an oxidizer. Fuel cells have a structure composed of a pair of electrodes with electrolyte therebetween. Hydrogen, hydrocarbon, alcohol, and the like can be used as the fuel, and air, chlorine, chlorine dioxide, and the like can be used as the oxidizer.

The fuel cell as a type of polymer electrolyte is a fuel cell using a polymer membrane having properties of a hydrogen ion exchange as an electrolyte. The polymer electrolyte fuel cell has high efficiency, high current density, and high power density, and also has a fast response to load, as compared to other types of the fuel cell. Most polymer electrolyte fuel cells include a stack for generating electric energy and a reformer for supplying a fuel to the stack. The reformer includes a reforming reactor and a heat source unit for supplying heat to the reforming reactor, and is generally operated at a higher temperature than the stack.

### SUMMARY OF THE INVENTION

The invention provides a fuel cell system for efficiently preheating a stack for a short time by controlling air velocity on the basis of a temperature change of the stack, while air heated by heat energy on a surface of a reformer is supplied to the stack.

In addition, the invention provides a fuel cell system for improving the efficiency and performance of the system by easily maintaining an optimal operation temperature of the system by controlling the airflow from the reformer to the stack, the airflow around the reformer, and/or the airflow around the stack.

According to an aspect of the invention, the fuel cell system includes: a reformer for generating a reformate gas by reforming hydrocarbon-based fuel using heat supplied from a specific heat source unit; a stack which generates electricity by electrochemically reacting an oxidizer with hydrogen in the reformate gas; and a fluid flow controller for controlling the air velocity on the basis of the temperature change of the stack and moving air around the reformer, in which the air is heated by the surface temperature of the reformer, into an area around the stack.

In an embodiment of the invention, the fluid flow controller includes a ventilator. The air velocity is changed by the temperature change of the stack. When the temperature change of the stack is lower than the standard value, the air velocity may decrease, and when the temperature change of the stack is higher than the standard value, the air velocity may increase.

In an embodiment of the invention, the fuel cell system includes a case for receiving the reformer and the stack. The fuel cell system may further include an air exhauster for exhausting air in the case. The operation speed of the air exhauster is changed in correspondence to an operation speed of the ventilator.

In an embodiment of the invention, the fuel cell system further includes a fluid flow separator which blocks flow of air around the reformer into the stack. The fluid flow separator includes a blocker disposed between the reformer and the stack, one or more other air exhausters, or a combination thereof.

In an embodiment of the invention, the fuel cell system includes a case, including a first section for receiving the reformer and a second section for receiving the stack. The fluid flow controller includes the ventilator, which is disposed at a partition wall of the first section and the second section. The operation speed of the ventilator is changed in correspondence to the temperature change of the stack. In other words, when the temperature change of the stack is lower than the standard value, the operation speed of the ventilator may decrease, and when the temperature change of the stack is higher than the standard value, the operation speed of the ventilator may be maintained. The fuel cell system may further include an air exhauster for exhausting air in the second section. The operation speed of the air exhauster is synchronized with the operation speed of the ventilator.

In an embodiment of the invention, the fuel cell system may further include another air exhauster for exhausting air in the first section.

In an embodiment of the invention, the fuel cell system may further include a blocker which blocks the flow of air between the first section and the second section. The blocker includes a cover attached to the ventilator.

In an embodiment of the invention, the fuel cell system may further include a WGS unit disposed in a third section, which is specially included in the case, a PROX unit disposed in the first section, and an air pump disposed in the second section.

A cold stack or frozen stack can be preheated in a short time using waste heat on the surface of the reformer according to embodiments of the present invention. In addition, the operational time of the stack or whole system is decreased and the temperature in the system is maintained at optimum level, thereby stably operating the fuel cell system for a long time, by controlling the airflow around the reformer, the airflow around the stack, and/or the airflow from the reformer to the stack. In addition, energy efficiency of the fuel cell system can be increased and the manufacturing cost thereof can be decreased because there is no requirement for a specific heater for preheating the cold stack.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic diagram of a fuel cell system according to a first embodiment of the present invention;

FIG. 2 is a schematic diagram of a fluid flow controller as depicted in FIG. 1;

FIG. 3 is a schematic diagram of a fuel cell system according to a second embodiment of the present invention;

FIG. 4 is a schematic diagram of a fuel cell system according to a third embodiment of the present invention;

FIG. 5 is a schematic diagram of a fuel cell system according to a fourth embodiment of the present invention; and

FIG. 6 is a graph illustrating the temperature change of a stack depending on control of the flow rate in a ventilator.

### DETAILED DESCRIPTION OF THE INVENTION

In the following detailed description, only certain exemplary embodiments of the present invention have been shown and described, simply by way of illustration. As those skilled in the art will realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on another element or be indirectly on another element with one or more intervening elements interposed therebetween.

Also, when an element is referred to as being “connected to” another element, it can be directly connected to another element or be indirectly connected to another element with one or more intervening elements interposed therebetween. Hereinafter, like reference numerals refer to like elements.

In describing the embodiments, well-known functions or constructions will not be described in detail since they may unnecessarily obscure the understanding of the present invention. In addition, it will be appreciated that like reference numerals refer to like elements throughout even though they are shown in different figures. Furthermore, when a first element is described as being coupled to a second element, the first element may be not only directly coupled to the second element but may also be indirectly coupled to the second element via a third element. Moreover, when a first layer is provided on a second layer, the first layer may be provided directly on the second layer or a third layer may be interposed therebetween. Besides, in the figures, the thickness and sizes of each layer may be exaggerated for convenience of description and clarity, and may be different from the actual thickness and size.

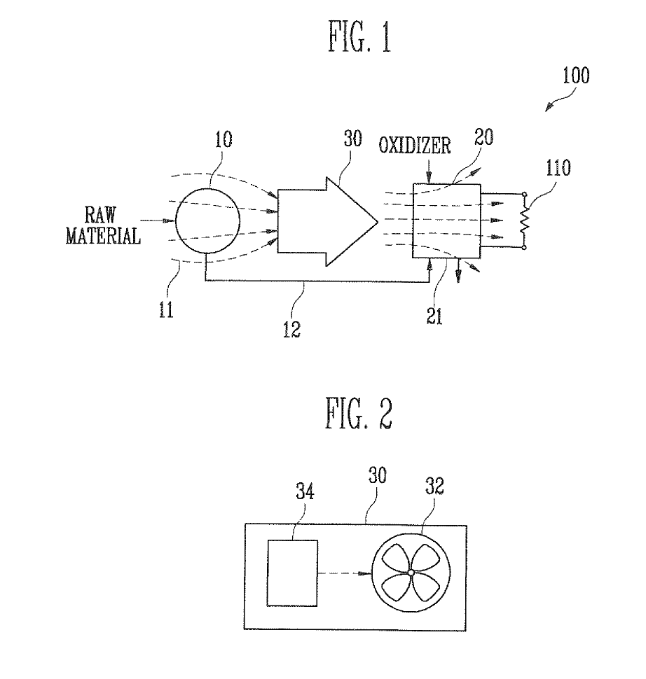

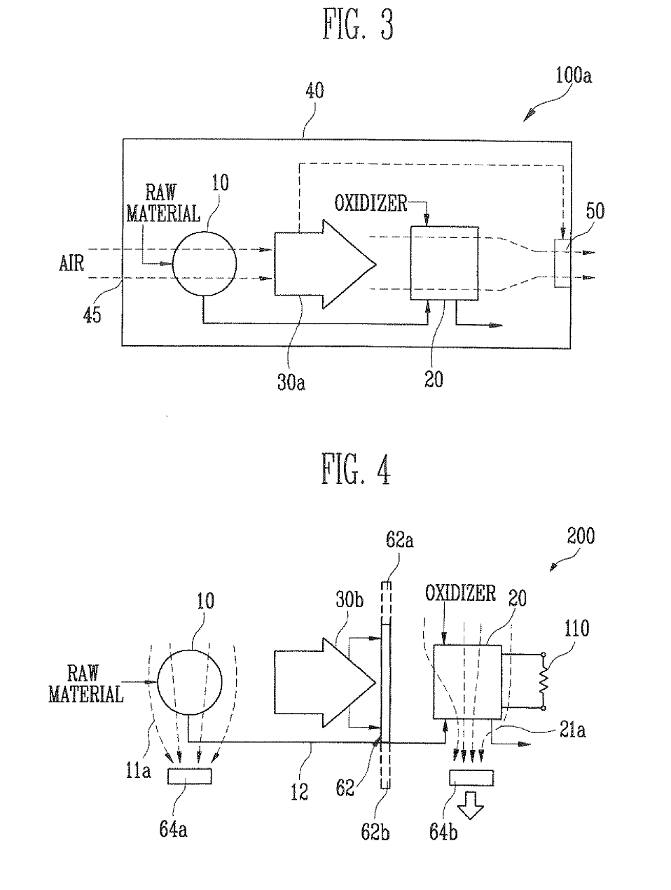

FIG. 1 is a schematic diagram of a fuel cell system according to a first embodiment of the present invention, while FIG. 2 is a schematic diagram of a fluid flow controller as depicted in FIG. 1.

Referring to FIG. 1, the fuel cell system 100 includes a reformer 10, a stack 20, and a fluid flow controller 30.

The reformer 10 is a device for generating the reformate gas by reforming the hydrocarbon-based fuel. The reformer 10 can be implemented by means of a steam catalytic reforming, partial oxidation reaction, and/or an auto thermal reforming, and the like. In addition, the reformer 10 includes a specific heat source unit (not shown) for supplying required heat in the reforming reaction. A catalytic combustor or a burner generating heat can implement the heat source unit by combusting the fuel. There is a difference depending on the type of fuel, but the reformer 10 is operated about several hundreds temperature ° C. Methanol, liquid petroleum gas (LPG), gasoline, and the like can be generally used as the fuel.

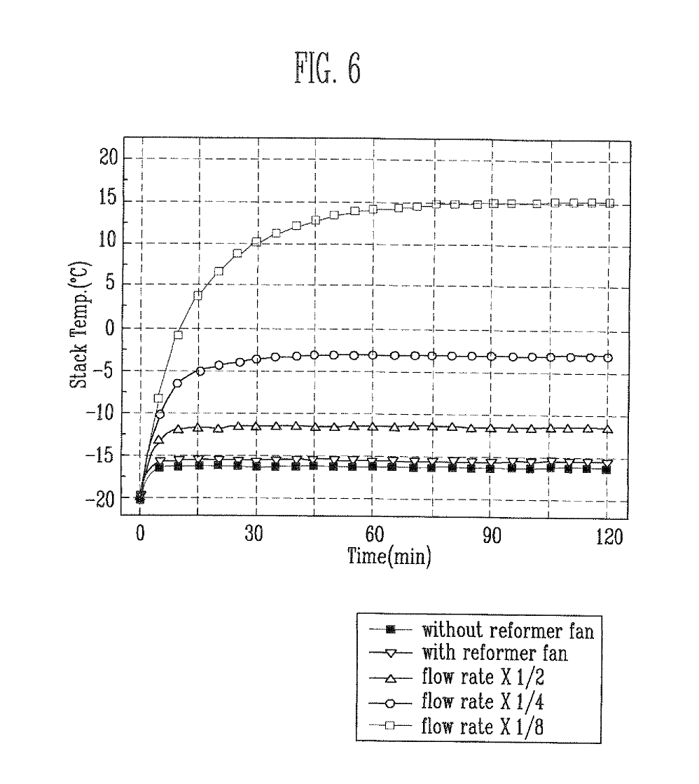

The fuel cell system 100 can include a WGS unit and a PROX unit (see FIG. 5). CO in the reformate gas can be decreased below 100 ppm by connecting the WGS unit to the rear end of the reformer 10, and the PROX unit to the rear end of the WGS unit. In addition, a specific air pump can be included for supplying oxygen to the PROX unit. The PROX unit is operated as a carbon monoxide reducing unit which decreases the carbon monoxide content in the hydrogen gas mixture, and the WGS unit is operated as the reforming unit connected to the rear end of the reformer 10 and/or a carbon monoxide reducing unit connected to the front end of the PROX unit. The reforming system, including the reformer 10, the WGS unit and the PROX unit, supplies hydrogen gas mixture having less than 10 ppm carbon monoxide to the stack 20 through a pipe.

The stack 20 is a device which directly converts chemical energy into electric energy by electrochemically reacting hydrogen with an oxidizer. The stack 20 can include a flat plate type device or a stacked plate type device formed by connecting a plurality of cells in a series or in a row. According to this embodiment, the stack 20 is implemented by means of a polymer electrolyte fuel cell using hydrogen in a hydrogen gas mixture as the fuel.

When stopping the system, water in the stack 20 may be frozen during the winter or the cold region, so that it can be a problem in reactivating the system. Therefore, the frozen water is removed by supplying the specific heat source to the system, and then the system should be reactivated when left for a long time at below standard temperature or activating at below standard temperature. In general, the system should be equipped with a specific heater, such as an electric heater, to transfer heat to the stack 20 in cold and frozen operations. However, if the specific stack heater is included, the system increases in volume and decreases in efficiency, and the manufacturing cost increases. Therefore, this embodiment intends to effectively preheat cold or frozen stack 20, using the waste heat that will be discharged from the surface of the reformer 10.

The fluid flow controller 30 includes a ventilator 32, and the controller 34 for controlling the operation of the ventilator 32 as depicted, for example, in FIG. 2. The ventilator 32 includes a fan. The controller 34 can be implemented by at least a portion of the functions of a high performance microprocessor or a logic circuit using a flip-flop.

The fluid flow controller 30 controls by force so as to flow air heated by the surface temperature of the reformer 10 around the reformer into the stack 20 in the cold or frozen activation. As the fluid flow controller 30 operates in the cold or frozen operation of the stack 20, the airflow 11 (see FIG. 1) around the reformer 10 is formed so as to flow from the reformer 10 into the fluid flow controller 20, and the airflow 21 around the stack 20 is formed so as to flow from the fluid flow controller 30 into the stack 20.

In addition, the fluid flow controller 30 controls the flow rate of air or air velocity on the basis of the temperature change of the stack 20 when the fluid flow controller 30 controls so as to flow air heated around the reformer 10 into an area around the stack 20. For example, the fluid flow controller 30 can change air velocity depending on the temperature change of the stack. If the temperature change of the stack is lower than a predetermined standard value, the air velocity can be decreased, and if the temperature change of the stack is higher than the predetermined standard value, the air velocity can be maintained or increased. The standard value can be determined on the basis of the air velocity or flow rate of air at a normal operation speed, which is predetermined according to the ventilator.

FIG. 3 is a schematic diagram of a fuel cell system according to a second embodiment of the present invention.

Referring to FIG. 3, a fuel cell system 100a includes a reformer 10, a stack 20, a fluid flow controller 30a, a case 40, and a ventilator 50. The fluid flow controller 30a can be included in the controller 34 and the air exhauster 32 of FIG. 2.

The case 40 receives the reformer 10, the fluid flow controller 30a, and the stack 20. The case 40 includes a vent 45 formed in at least one or more regions adjacent to the reformer 10, such as in the sidewall, upper wall, and lower wall, which are adjacent to the reformer 10.

The ventilator 50 is attached to the case 40 so as to exhaust by force air in the case 40. The ventilator 50 is provided to discharge the air flowing toward the stack 20 through the fluid flow controller 30a to the outside of the case 40 through the stack 20. The operation speed of the ventilator 50 can be controlled by the fluid flow controller 30a for equally synchronizing with the operation speed of the exhauster 32 (FIG. 2).

According to this embodiment, by controlling the operation speed of the air ventilator 50 corresponding to the operation speed of the exhauster 32, most air around the reformer 10 is efficiently moved into an area around the stack 20, and the flow rate of air and air velocity flowing around the stack 20 are constantly maintained so that the preheating effect of the stack 20 can be increased.

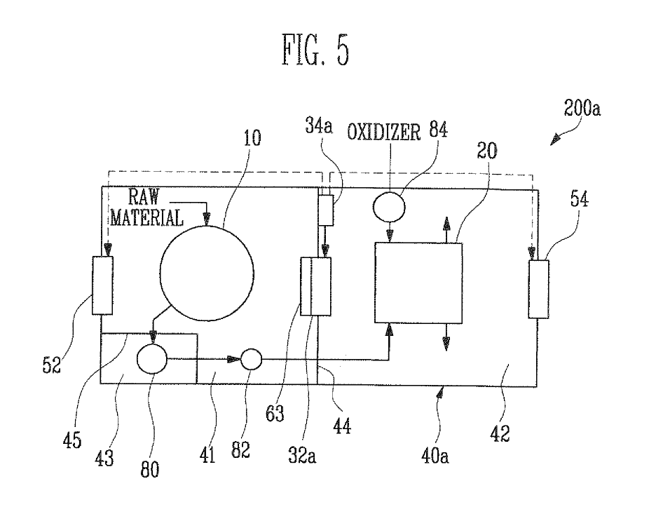

FIG. 4 is a schematic diagram of a fuel cell system according to a third embodiment of the present invention.

Referring to FIG. 4, a fuel cell system 200 includes a reformer 10, a stack 20, a fluid flow controller 30b, and a fluid flow separator 62. The fluid flow controller 30b can include the controller 34 and the ventilator 32 of FIG. 2.

The stack 20 can be normally operated after preheating of the stack 20 by the operation of the fluid flow controller 30b, and the fluid flow controller 30b operates so as not to flow high temperature air around the reformer 10 toward the stack 20.

For example, the fluid flow separator 62 may include a blocker which blocks the airflow by the ventilator 32. The blocker of fluid flow separate 62 may include a pair of blocking walls 62a and 62b disposed at a predetermined distance from each other. The blocker of fluid flow separate 62 can be converted into a closed state or an open state by controlling the fluid flow controller 30b.

In addition, for example, the fluid flow controller 30b may include a first ventilator 64a for leading the airflow 11a around the reformer 10 in the other direction instead of the stack disposition direction, and a second ventilator 64b for controlling the airflow 21a around the stack 20. The operations of the first and the second air exhausters 64a and 64b, respectively, can be independently controlled by the fluid flow controller 30b.

According to this embodiment, the temperature atmosphere around the reformer 10 having a surface temperature above 100° C. and the temperature atmosphere around the stack 20 having a greatly lower surface temperature relative to the reformer 10 can be independently maintained at the appropriated level by respectively controlling the airflow around the stack 20 and the airflow around the reformer 10, even if normally operating, as well as operating the fuel cell system 200.

FIG. 5 is a schematic diagram of a fuel cell system according to a fourth embodiment of the present invention.

Referring to FIG. 5, a fuel cell system 200a includes a reformer 10, a stack 20, a ventilator 32a, a controller 34a, a case 40a, a blocker 63, a first ventilator 52, and a second ventilator 54. The fuel cell system 200a may include a WGS unit 80, a PROX unit 82, and one or more air pumps 84.

The case 40a includes a first section 41, a second section 42, and a third section 43 in the case 40a. A first partition wall 44 compartmentalizes the first section 41 and the second section 42. A second partition wall 45 compartmentalizes the first section 41 and the third section 43.

The first partition wall 44 is equipped with the ventilator 32a for connecting the first section 41 and the second section 42 so that a fluid facilitation can be possible. In this embodiment, the ventilator 32a is implemented with a fan, and the blocker 63 is implemented with a cover included in the fan. The operations of the ventilator 32a and the blocker 63 are independently controlled by the controller 34a.

In addition, the case 40a includes a plurality of the vents (not shown) at appropriate positions. The vents allow air to flow freely between each of sections 41, 42 and 43, and to the outside of the case 40a.

The reformer 10 and the PROX unit 82 are received in the first section 41. The stack 20 and the air pump 84 are received in the second section 42. The WGS unit 80 is received in the third section 43.

A side of the case 40a includes the first air exhauster 52 establishing a connection between the inside of the first section 41 and the outside of the case 40a such that fluid facilitation can be made possible. Another side of the case 40a includes the second air exhauster 54 establishing a connection between the inside of the second section 42 and the outside of the case 40a such that fluid facilitation can be made possible. The operations of the first air exhauster 52 and the second air exhauster 54 are controlled by the controller 34a. The first and the second air exhausters 52 and 54, respectively, may correspond to the first and the second air exhauster 64a and 64b, respectively, as depicted in FIG. 4.

The operational process of the fuel cell system according to the fourth embodiment of the present invention is as follows.

The surface temperature of the reformer 10 increases rapidly at above 10° C. by the heat source unit (not shown) when operating the fuel cell system 200a. At this time, air around the inside of the first section 41 (i.e., air temperature around the reformer 10) increases quickly. In addition, the inside temperature of the entire system 200a, including the third section 43, increases, thereby preheating the entire system.

Specifically, the controller 34a controls heated air around the reformer 10 so as to heat the stack 20 and around the stack 20, and then to control the second air exhauster 54 by synchronizing the ventilator 32a to the second air exhauster 54. At this point, the controller 34a easily controls a preheating temperature and preheating time of the stack 20 by controlling the operation speed of the ventilator 32a on the basis of the temperature change of the stack 20.

In this embodiment of the present invention, when preheating the stack 20 at above 0° C. for about 10 min, with the frozen stack 20 having a temperature of −20° C., the temperature change of the stack 20 required per 1 min is 2° C. At this point, the controller 34a controls in such a manner that, if the temperature change of the stack 20 is lower than 2° C. as the standard value, the operation speed of the ventilator 32a (which is predetermined as the predetermined operation speed) is decreased, and if the temperature change of the stack per 1 min is higher than 2° C., the operation speed of the ventilator 32a is maintained in the present state or is increased by a few points.

In another embodiment of the present invention, when the stack 20 which is frozen at −20° C. is preheated to 0° C. after 10 mins, the temperature change of the stack 20 for a limited preheating time (i.e., 10 mins) may rapidly increase at the very beginning, and then may have a gently curved type. In this case, the controller 34a is included for changing from the high standard value to the low standard value, in which the values are the temperature change of the standard value required for the stack within 10 mins preheating time. For example, after moving in some curve (such as a curve that is ⅛ times as long as the flow velocity in FIG. 6), 10 mins is divided by the predetermined time interval (such as an interval of 30 sec), and then the standard value of the temperature change required in the stack 20 can be determined by a slope of each tangential according to the curve at each point.

The stack 20, properly connected by the fluid flow controller, generates electric energy and heat by electrochemically reacting oxygen (oxidizer), contained within air supplied to a cathode through the air pump 84, with hydrogen supplied to an anode through the reformer 10, the WGS unit 80 and the PROX unit 82, and is normally moved.

If the stack 20 starts to be normally operated at a predetermined temperature (such as, about 60° C.), the controller 34a stops the ventilator 32a, and operates the blocker 63 to block the airflow between the first section 41 and the second section 42. In addition, the controller 34a independently operates the first air exhauster 52 and the second air exhauster 54 so as to maintain the proper level of the inside temperatures in the first section 41 and the second section 42.

In another part, when the stack 20 is moved under room temperature or high temperature, the controller 34a controls so as not to operate the ventilator 34a.

FIG. 6 is a graph illustrating the temperature change of a stack depending on control of the flow rate in a ventilator.

Referring to FIG. 6, the process of preheating the stack 20 in the fuel cell system 200a depicted in FIG. 5 was tested in preparing the ventilators having the specific types and volumes, and changing the operation speed. As a result, it was confirmed that the preheating effect of the stack 20 was achieved at lower operation speed (such as the operation speed of ⅛ times) than a regular operation speed according to a regular volume of the ventilator 34a. In FIG. 6, the reformer fan corresponds to the first air exhauster 52.

As shown by the results mentioned above, the ventilator 34a used in the fuel cell system 200a of the fourth embodiment of the present invention can have a predetermined normal operation speed (such as, the operation speed of ⅛ times as long as the regular operation speed) for preheating the stack 20 when operating the system 200a.

Therefore, in the fuel cell system 200a according to the fourth embodiment of the present invention, the airflow generated by the ventilator 34a at normal operation speed of the ventilator 34a is determined as the basic airflow. In addition, the temperature change of the stack 20 is measured. If the temperature change of the stack 20 is lower than the predetermined standard temperature value required for the stack 20, the ventilator 34a is controlled so as to operate at a lower operation speed than the normal operation speed of the ventilator 34a, and if the temperature change of the stack 20 is higher than the standard temperature change, the ventilator 34a is controlled so as to maintain normal operation speed.

In another part, the case volume, the inside volumes of the first section 41 and the second section 42, the surface area of the stack 20, type and performance of the ventilators 34a, and the like can have various types, configurations and performances. However, according to the stack-preheating mode of the embodiments of the present invention, the stack 20 can be quickly and efficiently preheated by air heated around the reformer 10. For example, if the stack 20 is frozen at −20° C., the stack 20 can be quickly preheated to 0° C. after about 10 mins.

For such a reason, according to the embodiments of the present invention, the whole fuel cell system or the stack can be preheated quickly and efficiently by supplying the proper flow rate of air or the airflow in which the air is heated by the surface temperature of the reformer 10.

While the present invention has been described in connection with certain exemplary embodiments, it is to be understood that the invention is not limited to the disclosed embodiments but, on the contrary, it is intended to cover various modifications and equivalent arrangements included within the spirit and scope of the appended claims, and equivalents thereof.

What is claimed is:

1. A fuel cell system, comprising:
a reformer which generates a reformate gas by reforming a fuel using a heat source unit;
a stack which generates electricity by electrochemically reacting an oxidizer with hydrogen in the reformate gas; and
a fluid flow controller which moves air around the reformer into an area around the stack, and controls an air velocity on the basis of a temperature change of the stack, wherein the air is heated by a surface temperature of the reformer.

2. The fuel cell system as claimed in claim 1, wherein the fluid flow controller includes a ventilator.

3. The fuel cell system as claimed in claim 2, wherein the air velocity is changed by the temperature change of the stack.

4. The fuel cell system as claimed in claim 2, further comprising a case which receives the reformer and the stack.

5. The fuel cell system as claimed in claim 4, further comprising an air exhauster which exhausts air in the case.

6. The fuel cell system as claimed in claim 5, wherein an operational speed of the air exhauster is changed in correspondence to an operational speed of the ventilator.

7. The fuel cell system as claimed in claim 2, further comprising a fluid flow separator which prevents the air around the reformer from flowing into the stack.

8. The fuel cell system as claimed in claim 7, wherein the fluid flow separator includes at least one of a blocker disposed between the reformer and the stack and at least one air exhauster.

9. The fuel cell system as claimed in claim 1, further comprising a case which includes a first section for receiving the reformer and a second section for receiving the stack.

10. The fuel cell system as claimed in claim 9, wherein the fluid flow controller includes a ventilator, and the ventilator is disposed at a partition wall between the first section and the second section.

11. The fuel cell system as claimed in claim 10, wherein an operational speed of the ventilator is changed according to the temperature change of the stack.

12. The fuel cell system as claimed in claim 10, further comprising an air exhauster which exhausts air in the second section.

13. The fuel cell system as claimed in claim 12, wherein an operational speed of the air exhauster is synchronized with the operational speed of the ventilator.

14. The fuel cell system as claimed in claim 12, further comprising another air exhauster which exhausts air in the first section.

15. The fuel cell system as claimed in claim 10, further comprising a blocker which blocks flow of air between the first section and the second section.

16. The fuel cell system as claimed in claim 15, wherein the blocker includes a cover attached to the ventilator.

17. The fuel cell system as claimed in claim 9, further comprising:
a WGS unit disposed in a third section included in the case;
a PROX unit disposed in the first section; and
an air pump disposed in the second section.
